(19) United States
(12) Patent Application Publication
(10) Pub. No.: US 2025/0226949 A1
(43) Pub. Date: Jul. 10, 2025

(54) METHODS AND APPARATUS OF RESOURCE MAPPING FOR PTRS

(71) Applicant: LENOVO (BEIJING) LIMITED, Beijing (CN)

(72) Inventors: Yi Zhang, Beijing (CN); Wei Ling, Beijing (CN); Chenxi Zhu, Fairfax, VA (US); Bingchao Liu, Beijing (CN); Lingling Xiao, Beijing (CN)

(21) Appl. No.: 18/836,817

(22) PCT Filed: Feb. 11, 2022
(86) PCT No.: PCT/CN2022/076040

§ 371 Date: Aug. 8, 2024

(51) Int. Cl. H04L 5/00; H04L 27/26; H04W 76/20

(52) U.S. Cl. CPC H04L 5/0051; H04L 27/261; H04W 76/20

(57) ABSTRACT

Methods and apparatus of resource mapping for PTRS are disclosed. The apparatus includes: a receiver that receives a signalling for Phase-Tracking Reference Signal (PTRS); and a processor that determines a plurality of PTRS resources including: a first set of PTRS resources associated with a first set of DMRS ports and a second set of PTRS resources associated with a second set of DMRS ports; wherein the first set of PTRS resources are determined according to a first resource mapping scheme, and the second set of PTRS resources are determined according to a second resource mapping scheme.

### FIELD

The subject matter disclosed herein relates generally to wireless communication and more particularly relates to, but not limited to, methods and apparatus of resource mapping for Phase-Tracking Reference Signal (PTRS).

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX), Transmit or Transmitter (TX), Physical Downlink Shared Channel (PDSCH), Physical Uplink Shared Channel (PUSCH), Channel State Information (CSI), Downlink Control Information (DCI), Demodulation Reference Signal (DMRS, or DM-RS), Frequency Division Multiple Access (FDMA), Index/Identifier (ID), Information Element (IE), Modulation Coding Scheme (MCS), Multiple Input Multiple Output (MIMO), Multi-User MIMO (MU-MIMO), Orthogonal Cover Code (OCC), Physical Resource Block (PRB), Random Access Radio Network Temporary Identifier (RA-RNTI), Resource Block (RB), Resource Element (RE), Radio Network Temporary Identifier (RNTI), Radio Resource Control (RRC), Reference Signal (RS), Sounding Reference Signal (SRS), Transmission and Reception Point (TRP), Cell Radio Network Temporary Identifier (C-RNTI), Configured Scheduling RNTI (CS-RNTI), Direct Current (DC), Frequency Range 1 (FR1), Frequency Range 2 (FR2), Paging RNTI (P-RNTI), System Information RNTI (SI-RNTI), SRS Resource Indicator (SRI), Technical Specification (TS), Configured Scheduling (CS), System Information (SI), Universal Terrestrial Radio Access Network (UTRAN), Quasi Co-Location (QCL), Semi-Persistent (SP), Semi-Persistent CSI RNTI (SP-CSI-RNTI), Phase-Tracking Reference Signal (PTRS, or PT-RS).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs (Transmit Receive Points) are studied. A TRP is an apparatus to transmit and receive signals, and is controlled by a gNB through the backhaul between the gNB and the TRP.

It is important to identify and specify necessary enhancements for both downlink and uplink MIMO for facilitating the use of large antenna array, not only for FR1 but also for FR2 to fulfil the request for evolution of NR deployments in Release 18.

### SUMMARY

Methods and apparatus of resource mapping for PTRS are disclosed.

According to a first aspect, there is provided an apparatus, including: a receiver that receives a signalling for Phase-Tracking Reference Signal (PTRS); and a processor that determines a plurality of PTRS resources including: a first set of PTRS resources associated with a first set of DMRS ports and a second set of PTRS resources associated with a second set of DMRS ports: wherein the first set of PTRS resources are determined according to a first resource mapping scheme, and the second set of PTRS resources are determined according to a second resource mapping scheme.

According to a second aspect, there is provided an apparatus, including: a transmitter that transmits a signalling for Phase-Tracking Reference Signal (PTRS); and a processor that determines a plurality of PTRS resources including: a first set of PTRS resources associated with a first set of DMRS ports and a second set of PTRS resources associated with a second set of DMRS ports; wherein the first set of PTRS resources are determined according to a first resource mapping scheme, and the second set of PTRS resources are determined according to a second resource mapping scheme.

According to a third aspect, there is provided a method, including: receiving, by a receiver, a signalling for Phase-Tracking Reference Signal (PTRS); and determining, by a processor, a plurality of PTRS resources including: a first set of PTRS resources associated with a first set of DMRS ports and a second set of PTRS resources associated with a second set of DMRS ports: wherein the first set of PTRS resources are determined according to a first resource mapping scheme, and the second set of PTRS resources are determined according to a second resource mapping scheme.

According to a fourth aspect, there is provided a method, including: transmitting, by a transmitter, a signalling for Phase-Tracking Reference Signal (PTRS); and determining, by a processor, a plurality of PTRS resources including: a first set of PTRS resources associated with a first set of DMRS ports and a second set of PTRS resources associated with a second set of DMRS ports: wherein the first set of PTRS resources are determined according to a first resource mapping scheme, and the second set of PTRS resources are determined according to a second resource mapping scheme.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure:

FIGS. 4A and 4B are schematic diagrams illustrating examples of PTRS resource mapping in accordance with some implementations of the present disclosure.

FIGS. 5A and 5B are schematic diagrams illustrating examples of PTRS resource mapping in accordance with some implementations of the present disclosure.

FIG. 6 is a flow chart illustrating steps of resource mapping for PTRS by UE or gNB as receiving device in accordance with some implementations of the present disclosure; and

FIG. 7 is a flow chart illustrating steps of resource mapping for PTRS by UE or gNB as transmitting device in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second,” “third,” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B,” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

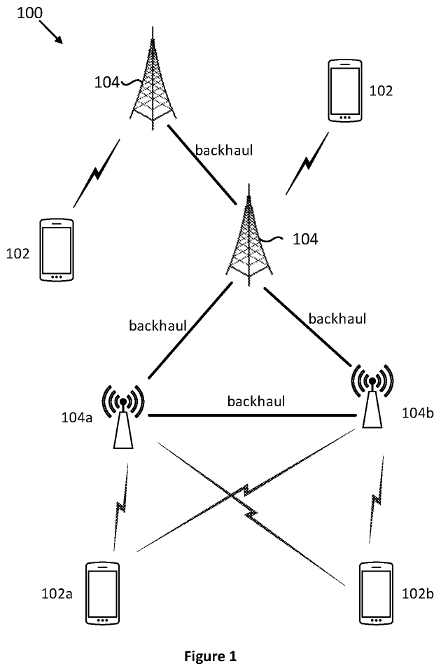

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, 102c, and 102d, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP” and “transmitting-receiving identity” may be used interchangeably throughout the disclosure.

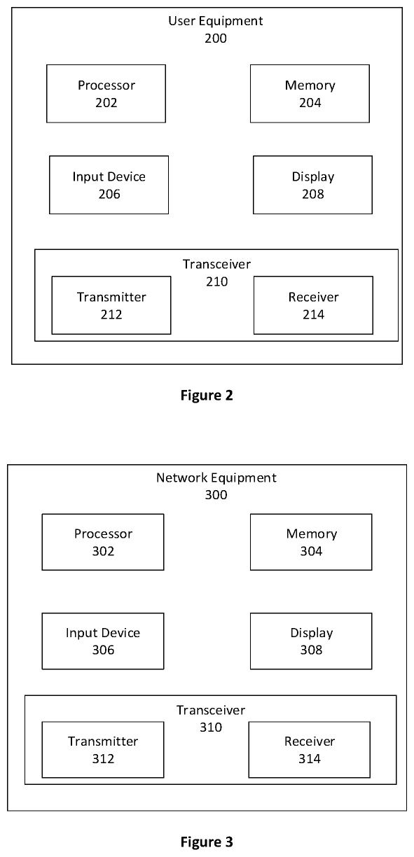

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

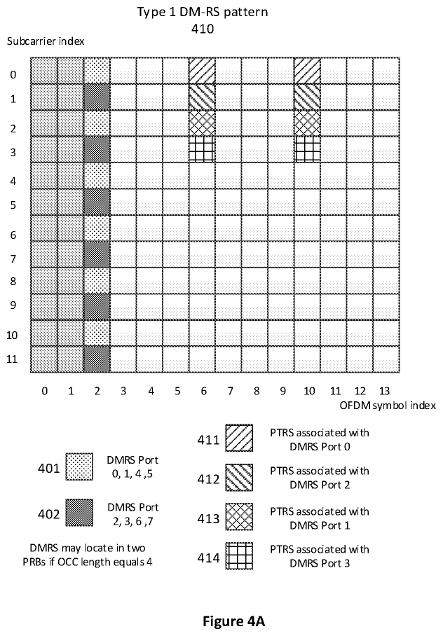

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

With the increasing need for multiplexing capacity of downlink and uplink demodulation reference signal (DMRS) from various use cases, there is a need for increasing the number of orthogonal ports for DMRS.

Based on current specification, a maximum of 4 orthogonal DMRS ports and 6 orthogonal DMRS ports are supported in the case of maxLength=1 for type 1 DMRS and type 2 DMRS, respectively; and a maximum of 8 orthogonal DMRS ports and 12 orthogonal DMRS ports are supported in the case of maxLength=2 for type 1 DMRS and type 2 DMRS, respectively. Resource elements (REs) in an RB for PTRS are associated with corresponding DMRS port. On account of UE not expected to be configured or scheduled with DMRS with TD-OCC and PTRS in the same slot in the case of above 6 GHz, the implicit association for determining PTRS RE location is defined with respect to DMRS ports 0-3 for Type 1 DMRS and DMRS ports 0-5 for Type 2 DMRS. However, the maximum number of orthogonal ports is doubled for both single-symbol DMRS and double-symbol DMRS in Release 18. That is, in Release 18, a maximum of 8 orthogonal DMRS ports and 12 orthogonal DMRS ports are supported in the case of maxLength=1 for type 1 DMRS and type 2 DMRS, respectively. Therefore, new or enhanced RE resource mapping schemes for PTRS are needed to be defined on account of the increased DMRS port number.

Downlink and uplink PTRS RE mapping schemes and the corresponding association relation are defined as follows in TS 38.211 and TS 38.214.

### TS 38.211 Uplink PTRS Mapping to Physical Resources

For the purpose of PT-RS mapping, the resource blocks allocated for PUSCH transmission are numbered from 0 to N_{RB}−1 from the lowest scheduled resource block to the highest. The corresponding subcarriers in this set of resource blocks are numbered in increasing order starting from the lowest frequency from 0 to N_{sc}^{RB}N_{RB}−1. The subcarriers to which the PT-RS shall be mapped are given by

$$\begin{matrix}k = {k}_{ref}^{RE} + ( {iK}_{PT - RS} + {k}_{ref}^{RB} ) {N}_{sc}^{RB} \\ {k}_{ref}^{R B} = \{ \begin{matrix}{n}_{RNTI} mod {K}_{PT - RS} & if {N}_{RB} mod {K}_{PT - RS} = 0 \\ {n}_{RNTI} mod ( {N}_{RB} mod {K}_{PT - RS} ) & otherwise\end{matrix}\end{matrix}$$

where
i=0, 1, 2 . . .
k_{ref}^{RE} is given by Table 6.4.1.2.2.1-1 for the DMRS port associated with the PT-RS port according to clause 6.2.3 in [6, TS 38.214]. If the higher-layer parameter resource ElementOffset in PTRS-UplinkConfig is not configured, the column corresponding to ‘offset00’ shall be used.
n_{RNTI} is the RNTI associated with the DCI scheduling the transmission using C-RNTI, CS-RNTI, MCS-C-RNTI, SP-CSI-RNTI, or is the CS-RNTI in case of configured grant
N_{RB} is the number of resource blocks scheduled
K_{PT-RS}∈{2,4} is given by [6, TS 38.214].

TABLE 6.4.1.2.2.1-1
The parameter k_{ref}^{RE}.

| | k_{ref}^{RE} | | | | | | | |
|---|---|---|---|---|---|---|---|---|
| DMRS | DMRS Configuration type 1 | | | | DMRS Configuration type 2 | | | |
| antenna | resourceElementOffset | | | | resourceElementOffset | | | |
| port \tilde{p} | offset00 | offset01 | offset10 | offset11 | offset00 | offset01 | offset10 | offset11 |
| 0 | 0 | 2 | 6 | 8 | 0 | 1 | 6 | 7 |
| 1 | 2 | 4 | 8 | 10 | 1 | 6 | 7 | 0 |
| 2 | 1 | 3 | 7 | 9 | 2 | 3 | 8 | 9 |
| 3 | 3 | 5 | 9 | 11 | 3 | 8 | 9 | 2 |
| 4 | — | — | — | — | 4 | 5 | 10 | 11 |
| 5 | — | — | — | — | 5 | 10 | 11 | 4 |

### TS 38.214 PTRS Transmission Procedure in the Case of not Enabling Transform Precoding

When transform precoding is not enabled and if a UE is configured with the higher layer parameter phaseTrackingRS in DMRS-UplinkConfig,
the higher layer parameters timeDensity and frequencyDensity in PTRS-UplinkConfig indicate the threshold values ptrs-MCSᵢ, i=1,2,3 and N_{RB,i}, i=0,1, as shown in Table 6.2.3.1-1 and Table 6.2.3.1-2, respectively.
if either or both higher layer parameters timeDensity and/or frequencyDensity in PTRS-UplinkConfig are configured, the UE shall assume the PT-RS antenna ports' presence and pattern are a function of the corresponding scheduled MCS and scheduled bandwidth in a corresponding bandwidth part as shown in Table 6.2.3.1-1 and Table 6.2.3.1-2, respectively,
   if the higher layer parameter timeDensity is not configured, the UE shall assume L_{PT-RS}=1.
   if the higher layer parameter frequencyDensity is not configured, the UE shall assume K_{PT-RS}=2.
if none of the higher layer parameters timeDensity and frequencyDensity in PTRS-UplinkConfig are configured, the UE shall assume L_{PT-RS}=1 and K_{PT-RS}=2.

TABLE 6.2.3.1-1
Time density of PT-RS as a function of scheduled MCS

| Scheduled MCS | Time density(_{LPT-RS}) |
|---|---|
| I_{MCS} < ptrs-MCS₁ | PT-RS is not present |
| ptrs-MCS1 ≤ I_{MCS} < ptrs-MCS2 | 4 |
| ptrs-MCS2 ≤ I_{MCS} < ptrs-MCS3 | 2 |
| ptrs-MCS3 ≤ I_{MCS} < ptrs-MCS4 | 1 |

TABLE 6.2.3.1-2
Frequency density of PT-RS as a function of scheduled bandwidth

| Scheduled bandwidth | Frequency density (K_{PT-RS}) |
|---|---|
| N_{RB} < N_{RB0} | PT-RS is not present |
| N_{RB0} ≤ N_{RB} < N_{RB1} | 2 |
| N_{RB1} ≤ N_{RB} | 4 |

The maximum number of configured PT-RS ports is given by the higher layer parameter maxNrofPorts in PTRS-UplinkConfig. The UE is not expected to be configured with a larger number of UL PT-RS ports than it has reported need for.

If a UE has reported the capability of supporting full-coherent UL transmission, the UE shall expect the number of UL PT-RS ports to be configured as one if UL-PTRS is configured.

For codebook or non-codebook based UL transmission, the association between UL PT-RS port(s) and DMRS port(s) is signalled by PTRS-DMRS association field in DCI format 0_1 and DCI format 0_2. For a PUSCH corresponding to a configured grant Type 1 transmission, the UE may assume the association between UL PT-RS port(s) and DMRS port(s) defined by value 0 in Table 7.3.1.1.2-25 or value “00” in Table 7.3.1.1.1.2-26 described in Clause 7.3.1 of [5, TS38.212].

For PUSCH scheduled by DCI format 0_0 or by activation DCI format 0_0, the UL PT-RS port is associated to DMRS port 0.

For non-codebook based UL transmission, the actual number of UL PT-RS port(s) to transmit is determined based on SRI(s) in DCI format 0_1 and DCI format 0_2 or higher layer parameter sri-ResourceIndicator in rrc-ConfiguredUplinkGrant. A UE is configured with the PT-RS port index for each configured SRS resource by the higher layer parameter ptrs-PortIndex configured by SRS-Config if the UE is configured with the higher layer parameter phaseTrackingRS in DMRS-UplinkConfig. If the PT-RS port index associated with different SRIs are the same, the corresponding UL DMRS ports are associated to the one UL PT-RS port.

For partial-coherent and non-coherent codebook-based UL transmission, the actual number of UL PT-RS port(s) is determined based on TPMI and/or number of layers which are indicated by Precoding information and number of layers field in DCI format 0_1 and DCI format 0_2 or configured by higher layer parameter precodingAndNnumberOfLayers:
if the UE is configured with the higher layer parameter maxNrofPorts in PTRS-UplinkConfig set to ‘n2’, the actual UL PT-RS port(s) and the associated transmission layer(s) are derived from indicated TPMI as:
PUSCH antenna port 1000 and 1002 in indicated TPMI share PT-RS port 0, and PUSCH antenna port 1001 and 1003 in indicated TPMI share PT-RS port 1.
   UL PT-RS port 0 is associated with the UL layer ‘x’ of layers which are transmitted with PUSCH antenna port 1000 and PUSCH antenna port 1002 in indicated TPMI, and UL PT-RS port 1 is associated with the UL layer ‘y’ of layers which are transmitted with PUSCH antenna port 1001 and PUSCH antenna port 1003 in indicated TPMI, where ‘x’ and/or ‘y’ are given by DCI parameter PTRS-DMRS association as shown in DCI format 0_1 and DCI format 0_2 described in Clause 7.3.1 of [5. TS38.212].

### TS 38.211 Downlink PTRS Mapping to Physical Resources

For the purpose of PT-RS mapping, the resource blocks allocated for PDSCH transmission are numbered from 0 to N_{RB}−1 from the lowest scheduled resource block to the highest. The corresponding subcarriers in this set of resource blocks are numbered in increasing order starting from the lowest frequency from 0 to N_{sc}^{RB}N_{RB}−1. The subcarriers to which the UE shall assume the PT-RS is mapped are given by

$$\begin{matrix}k = {k}_{r e f}^{RE} + ( i {K}_{PT - RS} + {k}_{r e f}^{R B} ) {N}_{s c}^{RB} \\ {k}_{r e f}^{R B} = \{ \begin{matrix}{n}_{RNTI} mod {K}_{PT - RS} & if {N}_{RB} mod {K}_{PT - RS} = 0 \\ {n}_{RNTI} mod ( {N}_{RB} mod {K}_{PT - RS} ) & otherwise\end{matrix}\end{matrix}$$

where
i=0, 1, 2, . . .
k_{ref}^{RB} is given by Table 7.4.1.2.2-1 for the DMRS port associated with the PT-RS port according to clause 5.1.6.3 in [6, TS 38.214]. If the higher-layer parameter resourceElementOffset in the PTRS-DownlinkConfig IE is not configured, the column corresponding to ‘offset00’ shall be used.
n_{NTI} is the RNTI associated with the DCI scheduling the transmission
N_{RB} is the number of resource blocks scheduled
K_{PT-RS}∈{2,4} is given by [6, TS 38.214].

TABLE 7.4.1.2.2-1
The parameter k_{ref}^{RE}.

| | k_{ref}^{RE} | | | | | | | |
|---|---|---|---|---|---|---|---|---|
| DMRS | DMRS Configuration type 1 | | | | DMRS Configuration type 2 | | | |
| antenna | resourceElementOffset | | | | resourceElementOffset | | | |
| port p | offset00 | offset01 | offset10 | offset11 | offset00 | offset01 | offset10 | offset11 |
| 1000 | 0 | 2 | 6 | 8 | 0 | 1 | 6 | 7 |
| 1001 | 2 | 4 | 8 | 10 | 1 | 6 | 7 | 0 |
| 1002 | 1 | 3 | 7 | 9 | 2 | 3 | 8 | 9 |
| 1003 | 3 | 5 | 9 | 11 | 3 | 8 | 9 | 2 |
| 1004 | — | — | — | — | 4 | 5 | 10 | 11 |
| 1005 | — | — | — | — | 5 | 10 | 11 | 4 |

### TS 38.214 PTRS Receiving Procedure

If a UE is configured with the higher layer parameter phaseTrackingRS in DMRS-DownlinkConfig,
the higher layer parameters timeDensity and frequencyDensity in PTRS-DownlinkConfig indicate the threshold values ptrs-MCSᵢ, i=1, 2, 3 and N_{RB,i}, i=0,1, as shown in Table 5.1.6.3-1 and Table 5.1.6.3-2, respectively.
if either or both of the additional higher layer parameters timeDensity and frequencyDensity are configured, and the RNTI equals MCS-C-RNTI, C-RNTI or CS-RNTI, the UE shall assume the PT-RS antenna port′ presence and pattern is a function of the corresponding scheduled MCS of the corresponding codeword and scheduled bandwidth in corresponding bandwidth part as shown in Table 5.1.6.3-1 and Table 5.1.6.3-2,
   if the higher layer parameter timeDensity given by PTRS-DownlinkConfig is not configured, the UE shall assume L_{PT-RS}=1.
   if the higher layer parameter frequencyDensity given by PTRS-DownlinkConfig is not configured, the UE shall assume K_{PT-RS}=2.
otherwise, if neither of the additional higher layer parameters timeDensity and frequencyDensity are configured and the RNTI equals MCS-C-RNTI, C-RNTI or CS-RNTI, the UE shall assume the PT-RS is present with L_{PT-RS}=1, K_{PT-RS}=2, and the UE shall assume PT-RS is not present when
   the scheduled MCS from Table 5.1.3.1-1 is smaller than 10, or
   the scheduled MCS from Table 5.1.3.1-2 is smaller than 5, or
   the scheduled MCS from Table 5.1.3.1-3 is smaller than 15, or
   the number of scheduled RBs is smaller than 3, or
otherwise, if the RNTI equals RA-RNTI, [MsgB-RNTI], SI-RNTI, or P-RNTI, the UE shall assume PT-RS is not present

TABLE 5.1.6.3-1
Time density of PT-RS as a function of scheduled MCS

| Scheduled MCS | Time density (L_{PT-RS}) |
|---|---|
| I_{MCS} < ptrs-MCS₁ | PT-RS is not present |
| ptrs-MCS1 ≤ I_{MCS} < ptrs-MCS2 | 4 |
| ptrs-MCS2 ≤ I_{MCS} < ptrs-MCS3 | 2 |
| ptrs-MCS3 ≤ I_{MCS} < ptrs-MCS4 | 1 |

TABLE 5.1.6.3-2
Frequency density of PT-RS as a function of scheduled bandwidth

| Scheduled bandwidth | Frequency density (K_{PT-RS}) |
|---|---|
| N_{RB} < N_{RB0} | PT-RS is not present |
| N_{RB0} ≤ N_{RB} < N_{RB1} | 2 |
| N_{RB1} ≤ N_{RB} | 4 |

The DL DMRS port(s) associated with a PT-RS port are assumed to be quasi co-located with respect to {′QCL-TypeA′ and ‘QCL-TypeD’}. If a UE is scheduled with one codeword, the PT-RS antenna port is associated with the lowest indexed DMRS antenna port among the DMRS antenna ports assigned for the PDSCH.

If a UE is scheduled with two codewords, the PT-RS antenna port is associated with the lowest indexed DMRS antenna port among the DMRS antenna ports assigned for the codeword with the higher MCS. If the MCS indices of the two codewords are the same, the PT-RS antenna port is associated with the lowest indexed DMRS antenna port assigned for codeword 0.

The RRC signalling for indicating PTRS is shown in the following information elements.

### PTRS-DownlinkConfig Information Element

| | |
|---|---|
| PTRS-DownlinkConfig ::= | SEQUENCE { |
| frequencyDensity | SEQUENCE (SIZE (2) ) OF INTEGER (1..276) |

OPTIONAL, -- Need S

| | |
|---|---|
| timeDensity | SEQUENCE (SIZE (3) ) OF INTEGER (0..29) |

OPTIONAL, -- Need S

| | |
|---|---|
| epre-Ratio | INTEGER (0..3) |

OPTIONAL, -- Need S

| | |
|---|---|
| resourceElementOffset | ENUMERATED { offset01, offset10, offset11 } |

```
OPTIONAL, -- Need S
  ...,
  [[
```

| | |
|---|---|
| maxNrofPorts-r16 | ENUMERATED {n1, n2} |

OPTIONAL -- Need R
]]
}

### PTRS-UplinkConfig Information Element

| | |
|---|---|
| PTRS-UplinkConfig ::= | SEQUENCE { |
| transformPrecoderDisabled | SEQUENCE { |
| frequencyDensity | SEQUENCE (SIZE (2) ) OF INTEGER (1..276) |
| OPTIONAL, -- Need S | |
| timeDensity | SEQUENCE (SIZE (3) ) OF INTEGER (0..29) |
| OPTIONAL, -- Need S | |
| maxNrofPorts | ENUMERATED {n1, n2}, |
| resourceElementOffset | ENUMERATED {offset01, offset10, offset11 |
| } OPTIONAL, -- Need S | |
| ptrs-Power | ENUMERATED {p00, p01, p10, p11} |
| } | |
| OPTIONAL, -- Need R | |
| transformPrecoderEnabled | SEQUENCE { |
| sampleDensity | SEQUENCE (SIZE (5) ) OF INTEGER |
| (1..276), | |
| timeDensityTransformPrecoding | ENUMERATED {d2} |
| OPTIONAL -- Need S | |
| } | |
| OPTIONAL, -- Need R | |
| ... | |
| } | |

Resource mapping for PTRS includes mapping schemes for determining RBs and REs in an RB. In detail, both the implicit association relation between PTRS and DMRS ports and the explicit RRC signalling for indicated specific association based on configuration parameter resourceElementOffset are used. Furthermore, PTRS does not exist together with DMRS with TD-OCC in the same slot for above 6 GHz system. The available PTRS RE mapping scheme is based on the implicit association between PTRS RE and DMRS ports 0-3 for Type 1 DMRS and DMRS ports 0-5 for Type 2 DMRS.

However, in Release 18, the maximum number of orthogonal ports is doubled for both single-symbol and double-symbol DMRS. More DMRS ports will be introduced to support high dimension MU-MIMO for more multiplexed UEs, where the maximum orthogonal DMRS port number can be 8 for Type 1 DMRS and 12 for Type 2 DMRS in the case of maxLength=1. Therefore, the PTRS resource mapping schemes need to be defined for PTRS REs associated with a larger number of DM-RS ports. In this disclosure, the resource mapping schemes with specific REs in an RB or different REs in two specific RBs are proposed where a large number of DMRS ports is supported, e.g., a maximum of 8 DMRS ports for type 1 DMRS and a maximum of 12 DMRS ports for type 2 DMRS in the case of maxLength=1. The proposed schemes are designed on top of legacy association between PTRS REs and DMRS ports to achieve compatibility for legacy UEs. RE collision for PTRS associated with different DMRS ports and possible collision with DC carrier are avoided in these proposed schemes.

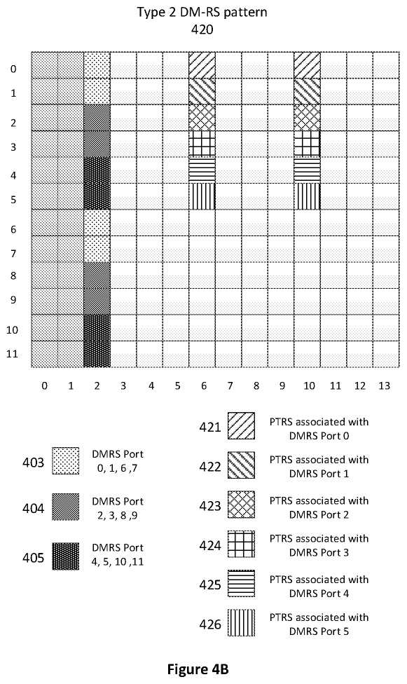

FIGS. 4A and 4B are schematic diagrams illustrating examples of PTRS resource mapping associated with the first set of DM-RS, i.e. from DM-RS port 0 to DM-RS port 3 for type 1 DMRS or from DM-RS port 0 to DM-RS port 5 for type 2 DMRS in accordance with some implementations of the present disclosure. As shown in FIG. 4A, in legacy type 1 DM-RS pattern 410, REs 401 are associated with DMRS ports 0, 1, 4, 5 and REs 402 are associated with DMRS ports 2, 3, 6, 7; and PTRS REs (i.e., REs for PTRS) 411 are associated with DMRS port 0, PTRS REs 412 are associated with DMRS port 2, PTRS REs 413 are associated with DMRS port 1, and PTRS REs 414 are associated with DMRS port 3, respectively, for Type 1 DMRS in the case of maxLength=1. For PTRS resource mapping associated with the second set of DM-RS, i.e. from DM-RS port 4 to DM-RS port 7, it is explained in details in later parts.

As shown in FIG. 4B, in legacy type 2 DM-RS pattern 420, REs 403 are associated with DMRS ports 0, 1, 6, 7, REs 404 are associated with DMRS ports 2, 3, 8, 9, and REs 405 are associated with DMRS ports 4, 5, 10, 11; and PTRS REs (i.e., REs for PTRS) 421 are associated with DMRS port 0, PTRS REs 422 are associated with DMRS port 1, PTRS REs 423 are associated with DMRS port 2, PTRS REs 424 are associated with DMRS port 3, PTRS REs 425 are associated with DMRS port 4, and PTRS REs 426 are associated with DMRS port 5, respectively, for Type 2 DMRS in the case of maxLength=1. For PTRS resource mapping associated with the second set of DM-RS, i.e. from DM-RS port 6 to DM-RS port 11, it is explained in details in later parts.

The associations between PTRS and the DMRS ports shown in FIGS. 4A and 4B correspond to those defined in TS 38.211 and TS 38.214 of the current specification as described above. DMRS ports 0-3 for type 1 DMRS or DMRS ports 0-5 for type 2 DMRS may be referred to as DMRS port set 0 for short.

To be compatible with legacy UE, the existing PTRS RE mapping scheme for PTRS associated with DMRS port set 0 is reused in the proposed PTRS RE mapping schemes with a larger number of DMRS ports. However, the resource mapping schemes for PTRS REs associated with DMRS ports 4-7 for Type 1 DMRS or DMRS ports 6-11 for Type 2 DMRS in the case of maxLength=1 (which may be referred to as DMRS port set 1 for short) need to be defined since DMRS ports 4-7 for Type 1 DMRS or DMRS ports 6-11 for Type 2 DMRS in the case of maxLength=1 are not supported in Release 15, 16 or 17, but are only introduced in Release 18. Several PTRS RE mapping schemes are proposed to determine PTRS RE associated with DMRS port set 1, while avoiding overlapping between PTRS associated with different DMRS ports. Also, some flexibility is provided to avoid collision with DC (Direct Current) carrier.

Schemes with REs in an RB with Different Subcarrier Offsets

For this type of schemes, different REs in an RB with only different subcarrier offset are used for PTRS associated with DMRS port set 0 and PTRS associated with DMRS port set 1. In detail, the following two schemes are proposed.

In a first scheme, one specific subcarrier offset is defined between PTRS associated with DMRS port set 0 and PTRS associated with DMRS port set 1. For example, subcarrier i is used for PTRS associated with DM-RS port m (i.e., one DMRS port in DMRS port set 0), where subcarrier i is determined based on the existing PTRS RE mapping scheme. Then, RE with subcarrier (i+k) mod 12 may be used for PTRS associated with DMRS port m+4 (i.e., one DMRS port in DMRS port set 1) in the case of Type 1 DMRS or with DMRS port m+6 (i.e., one DMRS port in DMRS port set 1) in the case of Type 2 DMRS, where k is a specific offset value. It is used to guarantee no RE overlapping between PTRS associated with different DMRS ports.

In one example, k may be 4 for Type 1 DMRS and 6 for type 2 DMRS; and then, the RE mapping table may be specified as Table 1 below for both uplink and downlink PTRS. In Table 1, for PTRS associated with DMRS port set 0, the same association relation as Table 6.4.1.2.2.1-1 for uplink PTRS and Table 7.4.1.2.2-1 for downlink PTRS are used: for PTRS associated with DMRS port set 1, the offset value of 4 for type 1 DMRS or 6 for type 2 DMRS is used (as shown in the bold part in Table 1).

TABLE 1
The parameter k_{ref}^{RE}.

| | k_{ref}^{RE} | | | | | | | |
|---|---|---|---|---|---|---|---|---|
| DMRS | DMRS Configuration type 1 | | | | DMRS Configuration type 2 | | | |
| antenna | resourceElementOffset | | | | resourceElementOffset | | | |
| port p | offset00 | offset01 | offset10 | offset11 | offset00 | offset01 | offset10 | offset11 |
| 1000 | 0 | 2 | 6 | 8 | 0 | 1 | 6 | 7 |
| 1001 | 2 | 4 | 8 | 10 | 1 | 6 | 7 | 0 |
| 1002 | 1 | 3 | 7 | 9 | 2 | 3 | 8 | 9 |
| 1003 | 3 | 5 | 9 | 11 | 3 | 8 | 9 | 2 |
| 1004 | 4 | 6 | 10 | 0 | 4 | 5 | 10 | 11 |
| 1005 | 6 | 8 | 0 | 2 | 5 | 10 | 11 | 4 |
| 1006 | 5 | 7 | 11 | 1 | 6 | 7 | 0 | 1 |
| 1007 | 7 | 9 | 1 | 3 | 7 | 0 | 1 | 6 |
| 1008 | — | — | — | — | 8 | 9 | 2 | 3 |
| 1009 | — | — | — | — | 9 | 2 | 3 | 8 |
| 1010 | — | — | — | — | 10 | 11 | 4 | 5 |
| 1011 | — | — | — | — | 11 | 4 | 5 | 10 |

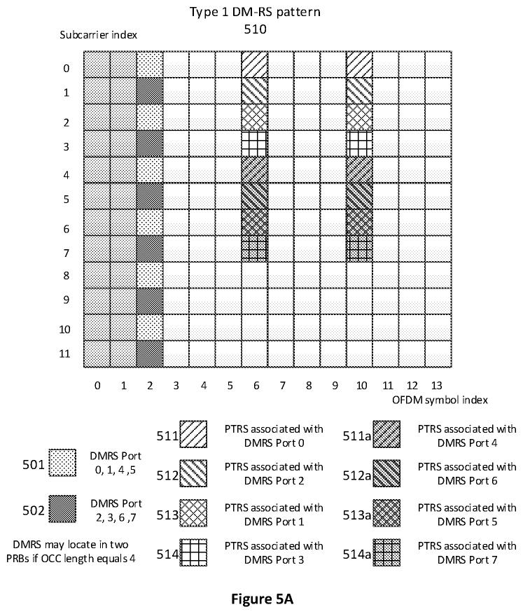

FIGS. 5A and 5B are schematic diagrams illustrating examples of PTRS resource mapping in accordance with some implementations of the present disclosure. The RE mapping patterns shown in FIGS. 5A and 5B illustrate examples of the mapping scheme for specific subcarrier offset corresponding to configuration parameter offset00 in Table 1.

As shown in FIG. 5A, in type 1 DM-RS pattern 510, REs 501 are associated with DMRS ports 0, 1, 4, 5 and REs 502 are associated with DMRS ports 2, 3, 6, 7; and PTRS REs 511 are associated with DMRS port 0, PTRS REs 512 are associated with DMRS port 2, PTRS REs 513 are associated with DMRS port 1, PTRS REs 514 are associated with DMRS port 3, PTRS REs 511a are associated with DMRS port 4, PTRS REs 512a are associated with DMRS port 6, PTRS REs 513a are associated with DMRS port 5, and PTRS REs 514a are associated with DMRS port 7, respectively, for Type 1 DMRS in the case of maxLength=1.

As shown in FIG. 5B, in type 2 DM-RS pattern 520, REs 503 are associated with DMRS ports 0, 1, 6, 7, REs 504 are associated with DMRS ports 2, 3, 8, 9, and REs 505 are associated with DMRS ports 4, 5, 10, 11; and PTRS REs 521 are associated with DMRS port 0, PTRS REs 522 are associated with DMRS port 1, PTRS REs 523 are associated with DMRS port 2, PTRS REs 524 are associated with DMRS port 3, PTRS REs 525 are associated with DMRS port 4, PTRS REs 526 are associated with DMRS port 5, PTRS REs 521a are associated with DMRS port 6, PTRS REs 522a are associated with DMRS port 7, PTRS REs 523a are associated with DMRS port 8, PTRS REs 524a are associated with DMRS port 9, PTRS REs 525a are associated with DMRS port 10, and PTRS REs 526a are associated with DMRS port 11, respectively, for Type 2 DMRS in the case of maxLength=1.

To improve flexibility, RRC signalling may be used to indicate this specific subcarrier offset. For example, a new parameter resourceElementGroupOffset may be imported in PTRS-DownlinkConfig and PTRS-UplinkConfig.

In a second scheme, REs based on two columns in Table 7.4.1.2.2-1 (for downlink PTRS) and Table 6.4.1.2.2.1-1 (for uplink PTRS) corresponding to two configured resourceElementOffset values can be used together for PTRS REs associated with two DMRS port sets (i.e., DMRS port set 0 and DMRS port set 1).

Furthermore, two resourceElementOffset values can be selected as an offset pair if there is no RE overlapping between REs from two combined columns corresponding to the two resource ElementOffset.

In one example, REs from PTRS with an offset pair:
(offset00, offset10),
(offset01, offset11),
(offset10, offset01), or
(offset11, offset00) for type 1 DMRS are used for PTRS REs associated with the two DMRS port sets with configuration parameters offset00, offset01, offset10, offset11, respectively.

In another example, REs from PTRS with an offset pair:
(offset00, offset10),
(offset01, offset11),
(offset10, offset00), or
(offset11, offset01) for type 2 DMRS are used for PTRS REs associated with the two DMRS port sets with configuration parameters offset00, offset01, offset10, offset11, respectively.

Table 2 illustrates the examples, and defines the RE offset (i.e. subcarrier index in an RB) values associated with the two DMRS port sets for the DMRS port associated with the PTRS. In Table 2, the bold part is derived based on the proposed scheme.

TABLE 2
The parameter k_{ref}^{RE}.

| | k_{ref}^{RE} | | | | | | | |
|---|---|---|---|---|---|---|---|---|
| DMRS | DMRS Configuration type 1 | | | | DMRS Configuration type 2 | | | |
| antenna | resourceElementOffset | | | | resourceElementOffset | | | |
| port p | offset00 | offset01 | offset10 | offset11 | offset00 | offset01 | offset10 | offset11 |
| 1000 | 0 | 2 | 6 | 8 | 0 | 1 | 6 | 7 |
| 1001 | 2 | 4 | 8 | 10 | 1 | 6 | 7 | 0 |
| 1002 | 1 | 3 | 7 | 9 | 2 | 3 | 8 | 9 |
| 1003 | 3 | 5 | 9 | 11 | 3 | 8 | 9 | 2 |
| 1004 | 6 | 8 | 2 | 0 | 4 | 5 | 10 | 11 |
| 1005 | 8 | 10 | 4 | 2 | 5 | 10 | 11 | 4 |
| 1006 | 7 | 9 | 3 | 1 | 6 | 7 | 0 | 1 |
| 1007 | 9 | 11 | 5 | 3 | 7 | 0 | 1 | 6 |
| 1008 | — | — | — | — | 8 | 9 | 2 | 3 |
| 1009 | — | — | — | — | 9 | 2 | 3 | 8 |
| 1010 | — | — | — | — | 10 | 11 | 4 | 5 |
| 1011 | — | — | — | — | 11 | 4 | 5 | 10 |

Furthermore, to improve flexibility, the offset pair may be configured by RRC signalling. For detailed RRC configuration, additional resourceElementOffset-r18 or resourceElementOffsetAdd-r18 may be introduced in PTRS-DownlinkConfig information element shown below with two alternatives.

### PTRS-DownlinkConfig Information Element (Alternative 1)

| | |
|---|---|
| PTRS-DownlinkConfig ::= | SEQUENCE { |
| frequencyDensity | SEQUENCE (SIZE (2) ) OF INTEGER (1..276) |

OPTIONAL, -- Need S

| | |
|---|---|
| timeDensity | SEQUENCE (SIZE (3) ) OF INTEGER (0..29) |

OPTIONAL, -- Need S

| | |
|---|---|
| epre-Ratio | INTEGER (0..3) |

OPTIONAL, -- Need S

| | |
|---|---|
| resourceElementOffset | ENUMERATED { offset01, offset10, offset11 } |

OPTIONAL, -- Need S

| | |
|---|---|
| resourceElementOffset-r18 | ENUMERATED { offset00, offset01, |

offset10, offset11, (offset00, offset10), (offset00, offset11), (offset01,
offset11), (offset10, offset01), (offset11, offset00), (offset10, offset00),

| | |
|---|---|
| (offset11, offset01), (offset01, offset10) } | OPTIONAL, -- Need S for Type 1 DMRS |
| resourceElementOffset-r18 | ENUMERATED { offset00, offset01, |

offset10, offset11, (offset00, offset10), (offset01, offset11), (offset10,

| | |
|---|---|
| offset00), (offset11, offset01) } | OPTIONAL, -- Need S for Type 2 DMRS |

```
  ...,
  [[
```

| | |
|---|---|
| maxNrofPorts-r16 | ENUMERATED {n1, n2} |

OPTIONAL Need R
]]
}

### PTRS-DownlinkConfig Information Element (Alternative 2)

| | |
|---|---|
| PTRS-DownlinkConfig ::= | SEQUENCE { |
| frequencyDensity | SEQUENCE (SIZE (2) ) OF INTEGER (1..276) |

OPTIONAL, -- Need S

| | |
|---|---|
| timeDensity | SEQUENCE (SIZE (3) ) OF INTEGER (0..29) |

OPTIONAL, -- Need S

| | |
|---|---|
| epre-Ratio | INTEGER (0..3) |

OPTIONAL, -- Need S

| | |
|---|---|
| resourceElementOffset | ENUMERATED { offset01, offset10, offset11} |

OPTIONAL, -- Need S

| | |
|---|---|
| resourceElementOffsetAdd-r18 | ENUMERATED { offset00, offset01, |
| offset10, offset11} | OPTIONAL, -- Need S |

```
  ...,
  [[
```

| | |
|---|---|
| maxNrofPorts-r16 | ENUMERATED {n1, n2} |

OPTIONAL -- Need P
]]
}

Any one of the two alternatives may be used to realize a flexible configuration. In one example with alternative 1, offset pairs are directly indicated by resourceElementOffset-r18. For DMRS Type 1, more candidate pairs can be identified on account of 8 available REs (4 REs not available) in an RB for PTRS associated with increased DMRS ports. For example, they may be
(offset00, offset10),
(offset01, offset11),
(offset10, offset01),
(offset11, offset00),
(offset10, offset00),
(offset11, offset01),
(offset00, offset11), and/or
(offset01, offset10).

For DMRS Type 2, less candidate pairs can be identified on account of 6 available REs (6 REs not available) in an RB for PTRS associated with increased DMRS ports. For example, they may be
(offset00, offset10),
(offset01, offset11),
(offset10, offset00), and/or
(offset11, offset01).

In another example with alternative 2, the second offset is indicated by resourceElementOffsetAdd-r18 and it is used in combination with offset value indicated by resourceElementOffset. Furthermore, restriction is made for configuration, in this example, that UE expects no RE overlapping between offset values (i.e. subcarrier index in an RB) from the column indicated by resourceElementOffset and offset values (i.e. subcarrier index in an RB) from the column indicated by resourceElementOffsetAdd-r18.

Schemes with REs in Different RBs

For this type of schemes, REs in two different RBs are used for PTRS associated with DMRS port set 0 and PTRS associated with DMRS port set 1. As described, the frequency density i.e. K_{PT-RS} is determined by scheduled bandwidth for data and threshold for PTRS frequency density, which may be no PTRS, 2 or 4. Thus, REs from at least 2 RBs can be used for PTRS transmission if PTRS exists. Therefore, REs from two specific RBs can be used for PTRS associated with two DMRS port sets. For PTRS resources associated with DMRS port set 0, the reference RB index, i.e. k1 can be determined according to the first scheduled RB and frequency density (i.e. 2 or 4 RB spacing) based on legacy formula as shown below for k_{ref}^{RB} with the resource blocks allocated for PDSCH transmission numbered from 0 to N_{RB}−1 from the lowest scheduled RB to the highest RB.

$${k}_{1} = {k}_{r e f}^{R B} = \{ \begin{matrix}\begin{matrix}{n}_{RNTI} mod {K}_{P T - R S} & if {N}_{RB} mod {K}_{P T - R S} = 0\end{matrix} \\ \begin{matrix}{n}_{RNTI} mod ( {N}_{R B} mod {K}_{P T - R S} ) & otherwise\end{matrix}\end{matrix}$$

For PTRS resources associated with DMRS port set 1, the RBs with reference RB index, i.e. k2 can be selected for other RBs in the same PTRS frequency sampling unit, i.e. 2 or 4 RBs according to PTRS frequency density to avoid RE overlapping.

In a first realization scheme,

$$k 2 = mod ( ( k 1 + 1 ) , {K}_{P T - R S} ) ,$$

where k2 may serve as k_{ref}^{RB} to determine PTRS REs associated with DMRS port set 1 based on a similar formula k=k_{ref}^{RE}+(iK_{PT-RS}+k_{ref}^{RB})N_{sc}^{RB}.

In a second realization scheme,

$$k 2 = mod ( ( k 1 + {K}_{P T - R S} / 2 ) , {K}_{P T - R S} ) ,$$

where k2 may serve as k_{ref}^{RB} to determine PTRS REs associated with DMRS port set 1 based on the similar formula k=k_{ref}^{RE}+(iK_{PT-RS}+k_{ref}^{RB})N_{sc}^{RB}.

For determining REs in the derived RB, the same association relation between PTRS and DMRS port as Table 6.4.1.2.2.1-1 for uplink PTRS and Table 7.4.1.2.2-1 for downlink PTRS may be reused for DMRS port set 0 and DMRS port set 1.

In some further examples, the two OFDM symbols, e.g., adjacent OFDM symbols, may be used for PTRS transmission associated with DMRS port set 0 and DMRS port set 1, where the same frequency domain location in two OFDM symbols, including PRB, RE in one PRB may be used. The frequency domain location can be derived based on available schemes as introduced for legacy scheme.

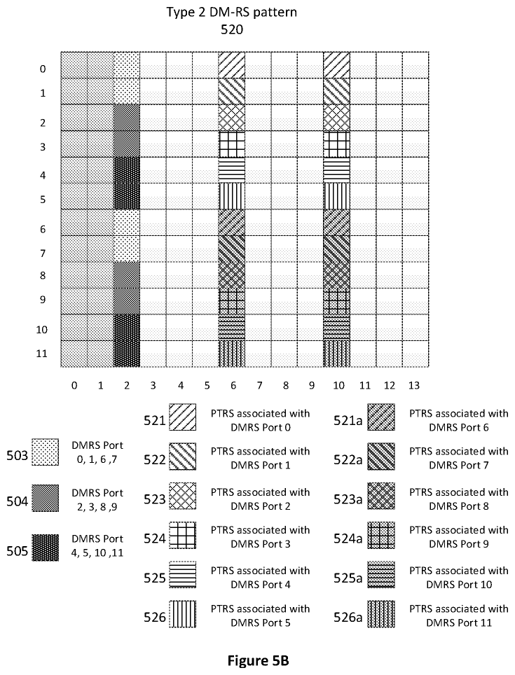

FIG. 6 is a flow chart illustrating steps of resource mapping for PTRS by UE 200 or gNB 300 as receiving device in accordance with some implementations of the present disclosure.

At step 602, the receiver 214 or 314 receives a signalling for Phase-Tracking Reference Signal (PTRS).

At step 604, the processor 202 or 302 determines a plurality of PTRS resources including: a first set of PTRS resources associated with a first set of DMRS ports and a second set of PTRS resources associated with a second set of DMRS ports; wherein the first set of PTRS resources are determined according to a first resource mapping scheme, and the second set of PTRS resources are determined according to a second resource mapping scheme.

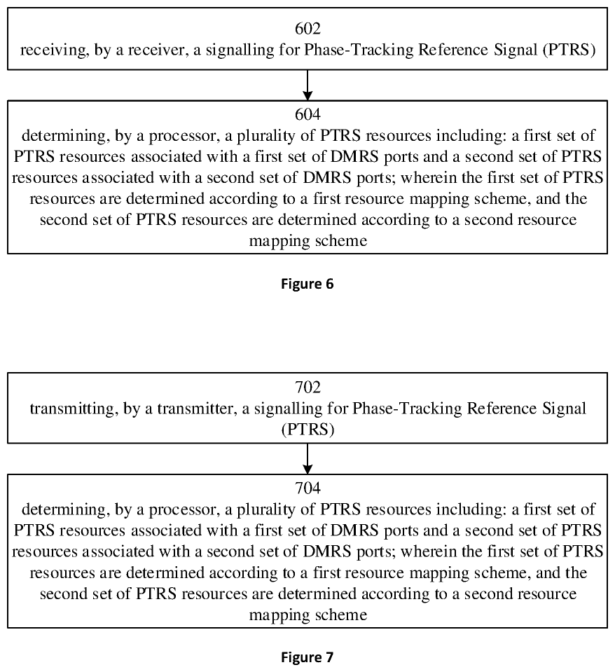

FIG. 7 is a flow chart illustrating steps of resource mapping for PTRS by UE 200 or gNB 300 as transmitting device in accordance with some implementations of the present disclosure.

At step 702, the transmitter 212 or 312 transmits a signalling for Phase-Tracking Reference Signal (PTRS).

At step 704, the processor 202 or 302 determines a plurality of PTRS resources including: a first set of PTRS resources associated with a first set of DMRS ports and a second set of PTRS resources associated with a second set of DMRS ports; wherein the first set of PTRS resources are determined according to a first resource mapping scheme, and the second set of PTRS resources are determined according to a second resource mapping scheme.

In one aspect, some items as examples of the disclosure concerning a method of reception of signalling for indicating DMRS ports by UE or gNB may be summarized as follows:

1. An apparatus, comprising:
a receiver that receives a signalling for Phase-Tracking Reference Signal (PTRS); and
a processor that determines a plurality of PTRS resources including: a first set of PTRS resources associated with a first set of DMRS ports and a second set of PTRS resources associated with a second set of DMRS ports:
wherein the first set of PTRS resources are determined according to a first resource mapping scheme, and the second set of PTRS resources are determined according to a second resource mapping scheme.

2. The apparatus of item 1, wherein the first set of PTRS resources and the second set of PTRS resources are mapped to a first group of Resource Elements (REs) and a second group of non-overlapping REs in a same Resource Block (RB).

3. The apparatus of item 1 or 2, wherein the second resource mapping scheme is a modified scheme based on the first resource mapping scheme with a group subcarrier offset, such that REs of the second set of PTRS resources are derived based on REs of the first set of PTRS resources and the group subcarrier offset.

4. The apparatus of item 3, wherein the group subcarrier offset is 4 for Type 1 DMRS and/or 6 for Type 2 DMRS.

5. The apparatus of item 1, wherein the PTRS resources determined according to the first and second resource mapping schemes comprise resources indicated by pairs of resourceElementOffset.

6. The apparatus of item 5, wherein the pairs of resourceElementOffset for type 1 DMRS include at least one selected from:
(offset00, offset10),
(offset01, offset11),
(offset10, offset01), and
(offset11, offset00),
and/or the pairs of resourceElementOffset for type 2 DMRS include at least one selected from:
(offset00, offset10),
(offset01, offset11),
(offset10, offset00), and
(offset11, offset01).

7. The apparatus of item 5, wherein the pairs of resourceElementOffset is indicated by RRC signalling.

8. The apparatus of item 5, wherein each one of the pairs of resourceElementOffset corresponds to one of configuration parameters: offset00, offset01, offset10, and offset11.

9. The apparatus of item 7, wherein the RRC signalling includes resourceElementOffset-r18 for indicating the pairs of resourceElementOffset.

10. The apparatus of item 7, wherein the RRC signalling includes resourceElementOffsetAdd-r18 for indicating a second resourceElementOffset for forming a pair of resourceElementOffset together with an existing resourceElementOffset.

11. The apparatus of item 1, wherein the first set of PTRS resources and the second set of PTRS resources are mapped to two distinct RBs corresponding to the first set of DMRS ports.

12. The apparatus of item 10, wherein the second set of PTRS resources in a second RB is determined using a reference RB index k2, which is derived based on a reference RB k1 for the first set of PTRS resources using:

$$\begin{matrix}k 2 = mod ( ( k 1 + 1 ) , {K}_{P T - R S} ) , or \\ k 2 = mod ( ( k 1 + {K}_{P T - R S} / 2 ) , {K}_{P T - R S} ) ,\end{matrix}$$

where K_{PT-RS} is PTRS frequency density.

13. The apparatus of item 10, wherein the second resource mapping scheme is

identical to the first resource mapping scheme in the determination of REs of the second set of PTRS resources in a second RB.

14. The apparatus of item 1, wherein the second set of PTRS resources are mapped to same frequency domain locations as the first set of PTRS resources, at a distinct Orthogonal Frequency Division Multiplexing (OFDM) symbol.

In another aspect, some items as examples of the disclosure concerning a method of transmission of signalling for indicating DMRS ports by UE or gNB may be summarized as follows:

15. An apparatus, comprising:
a transmitter that transmits a signalling for Phase-Tracking Reference Signal (PTRS); and
a processor that determines a plurality of PTRS resources including: a first set of PTRS resources associated with a first set of DMRS ports and a second set of PTRS resources associated with a second set of DMRS ports:
wherein the first set of PTRS resources are determined according to a first resource mapping scheme, and the second set of PTRS resources are determined according to a second resource mapping scheme.

16. The apparatus of item 15, wherein the first set of PTRS resources and the second set of PTRS resources are mapped to a first group of Resource Elements (REs) and a second group of non-overlapping REs in a same Resource Block (RB).

17. The apparatus of item 15 or 16, wherein the second resource mapping scheme is a modified scheme based on the first resource mapping scheme with a group subcarrier offset, such that REs of the second set of PTRS resources are derived based on REs of the first set of PTRS resources and the group subcarrier offset.

18. The apparatus of item 17, wherein the group subcarrier offset is 4 for Type 1 DMRS and/or 6 for Type 2 DMRS.

19. The apparatus of item 15, wherein the PTRS resources determined according to the first and second resource mapping schemes comprise resources indicated by pairs of resourceElementOffset.

20. The apparatus of item 19, wherein the pairs of resourceElementOffset for type 1 DMRS include at least one selected from:
(offset00, offset10),
(offset01, offset11),
(offset10, offset01), and
(offset11, offset00),
and/or the pairs of resourceElementOffset for type 2 DMRS include at least one selected from:
(offset00, offset10),
(offset01, offset11),
(offset10, offset00), and
(offset11, offset01).

21. The apparatus of item 19, wherein the pairs of resourceElementOffset is indicated by RRC signalling.

22. The apparatus of item 19, wherein each one of the pairs of resourceElementOffset corresponds to one of configuration parameters: offset00, offset01, offset10, and offset11.

23. The apparatus of item 21, wherein the RRC signalling includes resourceElementOffset-r18 for indicating the pairs of resourceElementOffset.

24. The apparatus of item 21, wherein the RRC signalling includes resourceElementOffsetAdd-r18 for indicating a second resourceElementOffset for forming a pair of resourceElementOffset together with an existing resourceElementOffset.

25. The apparatus of item 15, wherein the first set of PTRS resources and the second set of PTRS resources are mapped to two distinct RBs corresponding to the first set of DMRS ports.

26. The apparatus of item 24, wherein the second set of PTRS resources in a second RB is determined using a reference RB index k2, which is derived based on a reference RB k1 for the first set of PTRS resources using:

$$\begin{matrix}k 2 = mod ( ( k 1 + 1 ) , {K}_{P T - R S} ) , or \\ k 2 = mod ( ( k 1 + {K}_{P T - R S} / 2 ) , {K}_{P T - R S} ) ,\end{matrix}$$

where K_{PT-RS} is PTRS frequency density.

27. The apparatus of item 24, wherein the second resource mapping scheme is identical to the first resource mapping scheme in the determination of REs of the second set of PTRS resources in a second RB.

28. The apparatus of item 15, wherein the second set of PTRS resources are mapped to same frequency domain locations as the first set of PTRS resources, at a distinct Orthogonal Frequency Division Multiplexing (OFDM) symbol.

In a further aspect, some items as examples of the disclosure concerning UE or gNB for reception of signalling for indicating DMRS ports may be summarized as follows:

29. A method, comprising:
receiving, by a receiver, a signalling for Phase-Tracking Reference Signal (PTRS); and
determining, by a processor, a plurality of PTRS resources including: a first set of PTRS resources associated with a first set of DMRS ports and a second set of PTRS resources associated with a second set of DMRS ports:
wherein the first set of PTRS resources are determined according to a first resource mapping scheme, and the second set of PTRS resources are determined according to a second resource mapping scheme.

30. The method of item 29, wherein the first set of PTRS resources and the second set of PTRS resources are mapped to a first group of Resource Elements (REs) and a second group of non-overlapping REs in a same Resource Block (RB).

31. The method of item 29 or 30, wherein the second resource mapping scheme is a modified scheme based on the first resource mapping scheme with a group subcarrier offset, such that REs of the second set of PTRS resources are derived based on REs of the first set of PTRS resources and the group subcarrier offset.

32. The method of item 31, wherein the group subcarrier offset is 4 for Type 1 DMRS and/or 6 for Type 2 DMRS.

33. The method of item 29, wherein the PTRS resources determined according to the first and second resource mapping schemes comprise resources indicated by pairs of resourceElementOffset.

34. The method of item 33, wherein the pairs of resourceElementOffset for type 1 DMRS include at least one selected from:
(offset00, offset10),
(offset01, offset11),
(offset10, offset01), and
(offset11, offset00),
and/or the pairs of resourceElementOffset for type 2 DMRS include at least one selected from:
(offset00, offset10),
(offset01, offset11),
(offset10, offset00), and (offset11, offset01).

35. The method of item 33, wherein the pairs of resourceElementOffset is indicated by RRC signalling.

36. The method of item 33, wherein each one of the pairs of resourceElementOffset corresponds to one of configuration parameters: offset00, offset01, offset10, and offset11.

37. The method of item 35, wherein the RRC signalling includes resourceElementOffset-r18 for indicating the pairs of resourceElementOffset.

38. The method of item 35, wherein the RRC signalling includes resourceElementOffsetAdd-r18 for indicating a second resourceElementOffset for forming a pair of resourceElementOffset together with an existing resourceElementOffset.

39. The method of item 29, wherein the first set of PTRS resources and the second set of PTRS resources are mapped to two distinct RBs corresponding to the first set of DMRS ports.

40. The method of item 38, wherein the second set of PTRS resources in a second RB is determined using a reference RB index k2, which is derived based on a reference RB k1 for the first set of PTRS resources using:

$$\begin{matrix}k 2 = mod ( ( k 1 + 1 ) , {K}_{P T - R S} ) , or \\ k 2 = mod ( ( k 1 + {K}_{P T - R S} / 2 ) , {K}_{P T - R S} ) ,\end{matrix}$$

where K_{PT-RS} is PTRS frequency density.

41. The method of item 38, wherein the second resource mapping scheme is identical to the first resource mapping scheme in the determination of REs of the second set of PTRS resources in a second RB.

42. The method of item 29, wherein the second set of PTRS resources are mapped to same frequency domain locations as the first set of PTRS resources, at a distinct Orthogonal Frequency Division Multiplexing (OFDM) symbol.

In a yet further aspect, some items as examples of the disclosure concerning UE or gNB for transmission of signalling for indicating DMRS ports may be summarized as follows:

43. A method, comprising:
transmitting, by a transmitter, a signalling for Phase-Tracking Reference Signal (PTRS); and
determining, by a processor, a plurality of PTRS resources including: a first set of PTRS resources associated with a first set of DMRS ports and a second set of PTRS resources associated with a second set of DMRS ports:
wherein the first set of PTRS resources are determined according to a first resource mapping scheme, and the second set of PTRS resources are determined according to a second resource mapping scheme.

44. The method of item 43, wherein the first set of PTRS resources and the second set of PTRS resources are mapped to a first group of Resource Elements (REs) and a second group of non-overlapping REs in a same Resource Block (RB).

45. The method of item 43 or 44, wherein the second resource mapping scheme is a modified scheme based on the first resource mapping scheme with a group subcarrier offset, such that REs of the second set of PTRS resources are derived based on REs of the first set of PTRS resources and the group subcarrier offset.

46. The method of item 45, wherein the group subcarrier offset is 4 for Type 1 DMRS and/or 6 for Type 2 DMRS.

47. The method of item 43, wherein the PTRS resources determined according to the first and second resource mapping schemes comprise resources indicated by pairs of resourceElementOffset.

48. The method of item 47, wherein the pairs of resourceElementOffset for type 1 DMRS include at least one selected from:
(offset00, offset10),
(offset01, offset11),
(offset10, offset01), and
(offset11, offset00),
and/or the pairs of resourceElementOffset for type 2 DMRS include at least one selected from:
(offset00, offset10),
(offset01, offset11),
(offset10, offset00), and
(offset11, offset01).

49. The method of item 47, wherein the pairs of resourceElementOffset is indicated by RRC signalling.

50. The method of item 47, wherein each one of the pairs of resourceElementOffset corresponds to one of configuration parameters: offset00, offset01, offset10, and offset11.

51. The method of item 49, wherein the RRC signalling includes resourceElementOffset-r18 for indicating the pairs of resourceElementOffset.

52. The method of item 49, wherein the RRC signalling includes resourceElementOffsetAdd-r18 for indicating a second resourceElementOffset for forming a pair of resourceElementOffset together with an existing resourceElementOffset.

53. The method of item 43, wherein the first set of PTRS resources and the second set of PTRS resources are mapped to two distinct RBs corresponding to the first set of DMRS ports.

54. The method of item 52, wherein the second set of PTRS resources in a second RB is determined using a reference RB index k2, which is derived based on a reference RB k1 for the first set of PTRS resources using:

$$\begin{matrix}k 2 = mod ( ( k 1 + 1 ) , {K}_{P T - R S} ) , or \\ k 2 = mod ( ( k 1 + {K}_{P T - R S} / 2 ) , {K}_{P T - R S} ) ,\end{matrix}$$

where K_{PT-RS} is PTRS frequency density.

55. The method of item 52, wherein the second resource mapping scheme is identical to the first resource mapping scheme in the determination of REs of the second set of PTRS resources in a second RB.

56. The method of item 43, wherein the second set of PTRS resources are mapped to same frequency domain locations as the first set of PTRS resources, at a distinct Orthogonal Frequency Division Multiplexing (OFDM) symbol.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive a signalling for Phase-Tracking Reference Signal (PTRS); and
determine a plurality of PTRS resources including: a first set of PTRS resources associated with a first set of DMRS ports and a second set of PTRS resources associated with a second set of DMRS ports;
wherein the first set of PTRS resources are determined according to a first resource mapping scheme, and the second set of PTRS resources are determined according to a second resource mapping scheme.

2. The UE of claim 1, wherein the first set of PTRS resources and the second set of PTRS resources are mapped to a first group of Resource Elements (REs) and a second group of non-overlapping REs in a same Resource Block (RB).

3. The UE of claim 1, wherein the second resource mapping scheme is a modified scheme based on the first resource mapping scheme with a group subcarrier offset, such that REs of the second set of PTRS resources are derived based on REs of the first set of PTRS resources and the group subcarrier offset.

4. The UE of claim 3, wherein the group subcarrier offset is 4 for Type 1 DMRS and/or 6 for Type 2 DMRS.

5. The UE of claim 1, wherein the PTRS resources determined according to the first and second resource mapping schemes comprise resources indicated by pairs of resourceElementOffset.

6. The UE of claim 5, wherein the pairs of resourceElementOffset for type 1 DMRS include at least one selected from:
(offset00, offset10),
(offset01, offset11),
(offset10, offset01), and
(offset11, offset00),
and/or the pairs of resourceElementOffset for type 2 DMRS include at least one selected from:
(offset00, offset10),
(offset01, offset11),
(offset10, offset00), and
(offset11, offset01).

7. The UE of claim 5, wherein the pairs of resourceElementOffset is indicated by RRC signalling.

8. The UE of claim 5, wherein each one of the pairs of resourceElementOffset corresponds to one of configuration parameters: offset00, offset01, offset10, and offset11.

9. The UE of claim 7, wherein the RRC signalling includes resourceElementOffset-r18 for indicating the pairs of resourceElementOffset.

10. The UE of claim 7, wherein the RRC signalling includes resourceElementOffsetAdd-r18 for indicating a second resourceElementOffset for forming a pair of resourceElementOffset together with an existing resourceElementOffset.

11. The UE of claim 1, wherein the first set of PTRS resources and the second set of PTRS resources are mapped to two distinct RBs corresponding to the first set of DMRS ports.

12. The UE of claim 10, wherein the second set of PTRS resources in a second RB is determined using a reference RB index k2, which is derived based on a reference RB k1 for the first set of PTRS resources using:
$$\begin{matrix}k 2 = mod ( ( k 1 + 1 ) , {K}_{P T - R S} ) , or \\ k 2 = mod ( ( k 1 + \frac{{K}_{P T - R S}}{2} ) , {K}_{P T - R S} ) ,\end{matrix}$$
where K_{PT-RS} is PTRS frequency density.

13. The UE of claim 10, wherein the second resource mapping scheme is identical to the first resource mapping scheme in the determination of REs of the second set of PTRS resources in a second RB.

14. The UE of claim 1, wherein the second set of PTRS resources are mapped to same frequency domain locations as the first set of PTRS resources, at a distinct Orthogonal Frequency Division Multiplexing (OFDM) symbol.

15. A base station, comprising:
at least one memory; and
at least one processor coupled with the at least one memory and configured to cause the base station to:
transmit a signalling for Phase-Tracking Reference Signal (PTRS); and
determine a plurality of PTRS resources including: a first set of PTRS resources associated with a first set of DMRS ports and a second set of PTRS resources associated with a second set of DMRS ports;
wherein the first set of PTRS resources are determined according to a first resource mapping scheme, and the second set of PTRS resources are determined according to a second resource mapping scheme.

16. A processor for wireless communication, comprising:
at least one controller coupled with at least one memory and configured to cause the processor to:
receive a signalling for Phase-Tracking Reference Signal (PTRS); and
determine a plurality of PTRS resources including: a first set of PTRS resources associated with a first set of DMRS ports and a second set of PTRS resources associated with a second set of DMRS ports;
wherein the first set of PTRS resources are determined according to a first resource mapping scheme, and the second set of PTRS resources are determined according to a second resource mapping scheme.

17. The processor of claim 16, wherein the first set of PTRS resources and the second set of PTRS resources are mapped to a first group of Resource Elements (REs) and a second group of non-overlapping REs in a same Resource Block (RB).

18. The processor of claim 17, wherein the second resource mapping scheme is a modified scheme based on the first resource mapping scheme with a group subcarrier offset, such that REs of the second set of PTRS resources are derived based on REs of the first set of PTRS resources and the group subcarrier offset.

19. The processor of claim 18, wherein the group subcarrier offset is 4 for Type 1 DMRS and/or 6 for Type 2 DMRS.

20. A method performed by a user equipment (UE), the method comprising:
receiving a signalling for Phase-Tracking Reference Signal (PTRS); and
determining a plurality of PTRS resources including: a first set of PTRS resources associated with a first set of DMRS ports and a second set of PTRS resources associated with a second set of DMRS ports;
wherein the first set of PTRS resources are determined according to a first resource mapping scheme, and the second set of PTRS resources are determined according to a second resource mapping scheme.
